(19) United States
(12) Patent Application Publication
(10) Pub. No.: US 2023/0306328 A1
(43) Pub. Date: Sep. 28, 2023

(54) EMPLOYMENT IDENTIFICATION METHOD AND SOFTWARE APPLICATION

(71) Applicants: Owen Court, Surrey (CA); Patrick Doyle, Calgary (CA)

(72) Inventors: Owen Court, Surrey (CA); Patrick Doyle, Calgary (CA)

(21) Appl. No.: 17/656,420

(22) Filed: Mar. 24, 2022

(51) Int. Cl. G06Q 10/06; G06Q 10/10; G06F 3/04817

(52) U.S. Cl. CPC G06Q 10/063112; G06Q 10/1053; G06F 3/04817

(57) ABSTRACT

The employment identification method and software application of the present invention facilitates an employment search for a fulfillment of an open job opportunity wherein the employer is provided job seekers having a correlation between the skillsets required for the job and the experience/credentials of the job seeker. The present invention provides a process wherein the job seeker creates a profile account wherein the profile account includes all necessary information about the job seekers credentials and experience. The employer creates an account within the software application of the present invention and enters the requirements for their available employment opportunities. The software application of the present invention executes an algorithm to match the employment opportunity requirements and the job seeker skillset and credentials. Upon a correlated match, the employer is provided with the job seekers information. The present invention facilitates communication from the employer to the job seeker subsequent a correlated match.

### FIELD OF THE INVENTION

The present invention relates generally to employment seeking, more specifically but not by way of limitation, an employment identification method for employers and employment seekers wherein the method and software of the present invention provides automated matching of job seeker skills and employment requirements providing automatic notification to the job seeker ensuing matching of job requirement parameters.

### BACKGROUND

Millions of individuals regularly look for jobs and employers are consistently seeking new workers to either add to their existing workforce or replace lost members of their workforce. This general process has occurred for decades and various tools and resources have been utilized to accomplish the matching of a job seeker with an employment opportunity. Traditional methods of publishing job opportunities is still utilized and has migrated from conventional print ads to electronic techniques such as but not limited to social media posts and other websites that provide listings of various job opportunities for different industries. Another resource that is commonly utilized is a recruiting agency. Recruiting agencies will utilize recruiters that first work with employers to understand the needs and requirements of the open job opportunities. Subsequently, the recruiter will leverage their network and other techniques to identify potential candidates, screen the candidates and present to the employer for review.

While the existing processes have been effective at matching job seekers with potential employers, the process is overall very cumbersome, time consuming and not job seeker centric. Existing methods and tools require significant effort on the part of the job seeker. Job seekers can spend hundreds of hours looking through resources in an attempt to identify a job opportunity for which they may be qualified. Furthermore, employers invest a significant amount of resources interviewing and selecting candidates for open job opportunities and during this process will often waste time on candidates who are not quite qualified for the opportunity.

Accordingly, there is a need for an automated employment identification method that provides automatic matching of job seeker skillset and job requirements for a job opportunity wherein the method of the present invention provides automated review of the aforementioned and notification to the job seeker when there is a high correlation between the job seeker skillsets and the job requirements.

### SUMMARY OF THE INVENTION

It is the object of the present invention to provide an employment identification method that provides automated matching of job requirements and job seeker skillset wherein the present invention provides employers a pool of job seekers who are actively seeking employment.

Another object of the present invention is to provide a method operable to provide automated notifications to a job seeker upon identification of a job opportunity having requirements with a strong correlation to the job seekers experience and/or skillset wherein the present invention wherein the geo-location of the employer and the job seeker is identified during the process of the present invention.

A further object of the present invention is to provide an employment identification method that provides automated matching of job requirements and job seeker skillset wherein the present invention further reduces the amount of time that job seekers spend applying for jobs through conventional techniques such as but not limited to employer websites.

Still another object of the present invention is to provide a method operable to provide automated notifications to a job seeker upon identification of a job opportunity having requirements with a strong correlation to the job seekers experience and/or skillset wherein the present invention provides facilitation of initial communication between the employer and the job seeker.

An additional object of the present invention is to provide an employment identification method that provides automated matching of job requirements and job seeker skillset wherein the present invention provides the ability for job seekers to inhibit viewing thereof by specifically identified employers.

Yet a further object of the present invention is to provide a method operable to provide automated notifications to a job seeker upon identification of a job opportunity having requirements with a strong correlation to the job seekers experience and/or skillset wherein the present invention provides the job seeker to identify potential employers as preferential providing prioritization to job opportunities with those employers.

Another object of the present invention is to a provide an employment identification method that provides automated matching of job requirements and job seeker skillset wherein the present invention will provide identification to the employer of job seekers who have previously worked for the employer.

An alternate object of the present invention is to provide a method operable to provide automated notifications to a job seeker upon identification of a job opportunity having requirements with a strong correlation to the job seekers experience and/or skillset wherein the present invention provides no visibility to available job openings to the job seeker at an employer until the employer has selected the job seeker for further review.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a flowchart of the process flow for a job seeker engaged with the present invention; and

FIG. 2 is a flowchart of the process flow for an employer engaged with the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated an employment identification method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

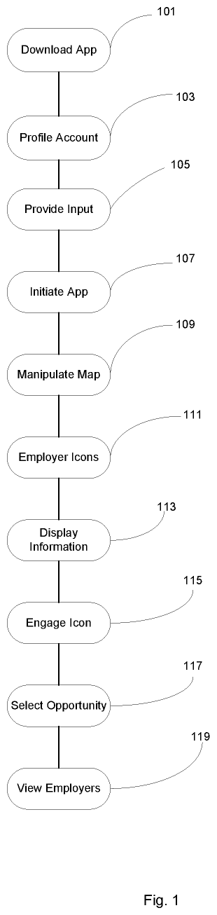

Now referring in particular to the Figures submitted herewith, employment identification method 100 provides an automated method that allows job seekers to be made available to employers wherein the software of the present invention provides criteria matching and subsequent a high correlation thereof will notify the employer of a potential candidate. Referring in particular to FIG. 1 submitted as a part hereof, this is an outline of the process flow of a job seeker as part of the employment identification method 100. In step 101, a job seeker will download the software application of the present invention to a mobile computing device or utilize a computing device to access the software via the Internet. It should be understood within the scope of the present application that the employment identification method 100 can be executed via either a software application or a software interface accessible via the Internet.

Step 103, the job seeker is prompted to create a profile account. It is intended within the scope of the present invention that the operator of the employment identification method 100 will not charge the job seeker to create a profile account. During creation of the profile account, the job seeker will enter parameters such as but not limited to: name, age, photograph, geo-location of residence or preferred work area, contact information and a personal statement. It should be understood within the scope of the present invention that some of the aforementioned parameters are optional such as but not limited to age and photograph. It should be further understood within the scope of the present invention that the job seeker must enter the geo-location as the algorithms of the software application of the employment identification method 100 utilizes this data for identifying a match of a job seeker and a job opportunity from an employer participating in the employment identification method 100.

In step 105, the job seeker will be presented a series of multiple choice questions wherein the job seeker is required to answer in order to complete creation of the account profile. By way of example but not limitation, some of the questions that the job seeker is asked is as follows. What is their geo-location, what industry is the job seeker seeking work, is the job seeker part time of full time employment, what is their relevant industry experience, what are their salary expectations, what is the job seekers availability, what is the job seekers level of education and what types of industry certifications does the job seeker have. In step 107, ensuing creation of the profile account for the job seeker at a point in time in which the job seekers data has been selected by an employer and the software application of the present invention has transmitted a notification to the job seeker, the job seeker will either open the software application or access the software via a website. Once the job seeker has opened the software application a graphical map is presented on which a graphic such as but not limited to a dot is shown wherein the graphic image represents the entered geo-location of the job seeker. The job seeker can manipulate the size of the map utilizing conventional techniques in step 109.

In step 111, the job seeker is presented a graphical icon that indicates the geo-location of an employer(s) with which the software of the present invention has matched and the job seeker and an employment opportunity wherein the profile account parameters and available employment opportunity were identified by the software as having a high correlation. While no specific correlation is required, it is desired within the scope of the present invention that the profile account data and the job requirement data have a correlation of at least 0.75. Step 113, the name of the employer, wage range for the position is presented adjacent to the graphical icon of the employers geo-location along with a graphical icon labeled more. In step 115, the job seeker activates the graphical icon labeled, more, which launches an alternate graphical window that provides additional information. The alternate graphical window provides information such as but not limited to: full name and location of employer, a description of the available employment opportunity, the wage range and hours of the employment opportunity, daily hours, and whether the employment opportunity is part time or full time. The job seeker is further present with a graphical icon labeled, express interest.

Step 117, if the job seeker desires to learn more about the employment opportunity, the job seeker will activate the graphical icon labeled, express interest. Once activated, the software application of the present invention will send the job seekers profile to the employer. It should be understood within the scope of the present invention that the software application of the present invention does not facilitate any additional type of communication between the employer and the job seeker at this point in the process. Once the software application has transmitted the profile account of the job seeker to the employer, the employer will initiate participation in the process of the employment identification method 100 as further discussed herein.

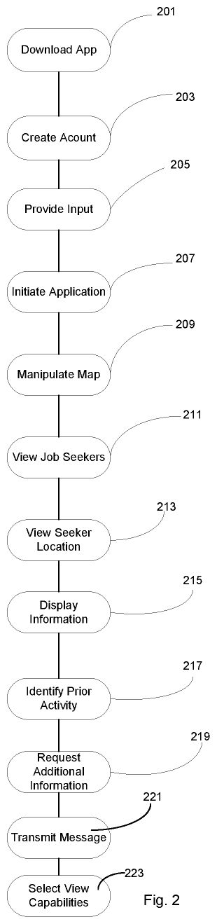

Referring now to FIG. 2 submitted as a part hereof, the process flow of an employer participating in the employment identification method 100 is diagrammed therein. In step 201, the employer will download the software application of the present invention or access a version thereof via the Internet. Step 203, the employer will create an account wherein the employer is charged a fee by the operator of the employment identification method 100 in order to create an account. During creation of the employer account profile, the employer will enter the name of the business, website link, location and a statement providing general information about the company. In step 205, the employer will be presented with a plurality of multiple choice questions regarding the employment opportunities that the employer currently has available. By way of example but not limitation, the questions presented to the employer are: location, industry, whether the employment opportunities are full time or part time, years experience required for the employment opportunity, salary range for the employment opportunity, work schedule for the employment opportunity, hour requirements for the employment opportunity, education level required for employment opportunity and any certifications required for the employment opportunity.

In step 207, at a time point subsequent to step 205, the employer will access the software application and be presented with a graphical map wherein the graphical map further includes an icon identifying the geo-location of the employer. In step 209, the employer can manipulate the scale of the map utilizing conventional methods such as a plus and minus graphical icon. In step 211, the software application provides notification of job seekers whom have expressed interest in the employment opportunity posted by the employer and that the software application has identified a correlation between the job seeker and the employment opportunity requirements. Step 213, the employer is presented with a graphical icon on the map wherein the graphical icon provides the geo-location of the job seeker(s) whom have expressed interest in the employment opportunity and the software application has determined the required correlation exists. In step 215, the employer is displayed the name of the person, photo if provided and an icon labeled, more information, adjacent to the graphical icon showing the geo-location of the job seeker(s).

Step 217, the employer is presented an alternate color graphical icon for any job seeker that has been previously employed by the employer. It should be understood within the scope of the present invention that the job seeker can be identified as having been previously employed by the employer utilizing various graphical techniques. In step 219, the employer engages the graphical icon, more information, which launches a separate graphical window wherein in this separate graphical window the employer is provided the profile account of the job seeker and is further presented with a graphical icon labeled, contact. Step 221, the employer selects the graphical icon, contact, wherein the software application provides an additional graphical window wherein this graphical window can facilitate direct messaging to the job seeker or provide a phone number and/or email providing a direct interface to utilize in order to contact the job seeker. In step 223, the employer initiates contact with the job seeker and subsequent interviews or the like proceed. It should be understood within the scope of the present invention that the employers can see other employers within the software application on the graphical map and as well all job seekers despite whether or not the preferred correlation has been established. The software application provides an option to an employer wherein the employer can view all job seekers or view only those job seekers having a desired correlation to the employment opportunities of the employer.

It is further contemplated within the scope of the present invention that the software application will further include a block feature wherein this feature allows an employer or a job seeker to inhibit a selected party to view them within the employment identification method 100. By way of example but not limitation, the aforementioned functionality could be utilized by a job seeker to inhibit a current employer from being matched or viewed by the current employer. Additionally, the software application provides the ability for the employer to designate preference for any job seeker with which an association exists. Furthermore, the present invention allows job seekers to specify preferred employers and prioritize them for possible employment opportunities. Moreover, the software application provides an ability for employers and job seekers to provide ratings of each other.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A method operable to identify potential employees for an employer wherein the method incorporates data parameters and geo-location to match employers with potential employees wherein the method comprises the steps of:
providing a software application, wherein the software application is available for interface via a mobile computing device or a desktop computing device;
registering a plurality of employers, wherein an operator of the method registers a plurality of employers, wherein registration of the plurality of employers includes account creation for each of the plurality of employers;
providing information regarding available employment opportunities, wherein the plurality of employers provides data regarding the employment opportunities, wherein the data includes geo-location of the employment opportunity;
presenting a graphical image of a map, wherein job seekers utilizing the software application to identify employment opportunities are presented with a graphical map of an area proximate to a geo-location of the job seeker;
reviewing the employment opportunities, wherein job seekers review available employment opportunities proximate to the geo-location of the job seeker, wherein the employment opportunities are identified on the graphical image of the map with an icon;
selecting at least one employment opportunity, wherein the job seeker selects at least one employment opportunity for review;
expressing an interest in the employment opportunity, wherein the job seeker engages an icon to provide notification of an interest in the employment opportunity;
correlating the data of the employment opportunity and qualification data of the job seeker, wherein the software application analyzes the data of the employment opportunity with the qualification data of the job seeker to calculate a correlation;
transmitting a notification to at least one of the plurality of employers, wherein the at least one of the plurality of employers is notified that a job seeker having a correlation to the available employment opportunity has expressed an interest;
reviewing the job seeker who has expressed an interest, wherein the at least one of the plurality of employers is presented a graphical image of a map in the software application wherein on the graphical image of the map an icon indicates a geo-location of the job seeker who has expressed an interest in the employment opportunity; and
transmitting a message to the job seeker, wherein the at least one of the plurality of employers transmits a message to the job seeker.

2. The method operable to identify potential employees for the employer wherein the method incorporates data parameters and geo-location to match employers with potential employees as recited in claim 1, and further including the step of collecting data from the job seeker, wherein the software application collects data through a questionnaire, wherein the data is work experience and qualifications of the job seeker.

3. The method operable to identify potential employees for the employer wherein the method incorporates data parameters and geo-location to match employers with potential employees as recited in claim 2, and further including the step of creating a profile account, wherein a job seeker utilizes the software application to create a profile account wherein the profile account includes the geo-location of the job seeker.

4. The method operable to identify potential employees for the employer wherein the method incorporates data parameters and geo-location to match employers with potential employees as recited in claim 3, and further including the step of charging a fee, wherein the plurality of employers are charged a fee during registration.

5. The method operable to identify potential employees for the employer wherein the method incorporates data parameters and geo-location to match employers with potential employees as recited in claim 4, and further including the step of indicating previous employment with the employer, wherein the graphical image of the map will display an icon of a different color for a job seeker that has been employed with an employer viewing the graphical image of the map.

6. The method operable to identify potential employees for the employer wherein the method incorporates data parameters and geo-location to match employers with potential employees as recited in claim 5, and further including the step of identifying a list of preferred employers, wherein the job seeker enters a list of preferred employers.

7. The method operable to identify potential employees for the employer wherein the method incorporates data parameters and geo-location to match employers with potential employees as recited in claim 6, and further including the step of inhibiting access to the profile account of the job seeker, wherein the job seeker identifies employers that will be inhibited from viewing the profile account of the job seeker.

8. The method operable to identify potential employees for the employer wherein the method incorporates data parameters and geo-location to match employers with potential employees as recited in claim 7, and further including the step of providing additional information about an employment opportunity, wherein the job seeker engages a graphical icon on the graphical image of the map so as to launch an additional graphical window containing details concerning the employment opportunity.

9. The method operable to identify potential employees for the employer wherein the method incorporates data parameters and geo-location to match employers with potential employees as recited in claim 8, and further including the step of viewing additional job seekers, wherein the plurality of employers can view job seekers with whom the software application has not calculated the correlation between the job seeker and employment opportunity.

10. A method operable to correlate job seeker qualification with employment opportunities wherein correlated job seekers are made available for review to employers wherein the method comprises the steps of:
providing a software application, said software application configured to be operable via a mobile computing device or a desktop computing device;
creating a profile account, wherein a multitude of job seekers will create a profile account within the software application;
collecting experience and qualification data from the multitude of job seekers, wherein the software application presents a plurality of questions to the multitude of job seekers so as to collect experience and qualification data;
identifying a geo-location of the multitude of job seekers, wherein the geo-location of the job seeker is included in the profile account;
registering a plurality of employers, wherein an operator of the method registers a plurality of employers;
establishing an account for the plurality of employers, wherein the plurality of employers enter data about the plurality of employers;
providing information regarding available employment opportunities, wherein the plurality of employers provide information about the available employment opportunities via answering a list of questions provided by the software application;
correlating the information on the employment opportunities and the experience and qualification data of the job seekers;
identifying correlated job seekers;
providing a graphical map to a job seeker, wherein the graphical map displays an icon for the geo-location of the job seeker and the plurality of employers having available employment opportunities;
reviewing available employment opportunities, wherein the job seekers will review the available employment opportunities presented on the graphical map;
expressing an interest in an employment opportunity, wherein the job seeker will express an interest in an employment opportunity via engaging an icon;
presenting job seekers to an employer, wherein the employer is presented on the graphical map an icon representing the geo-location of the job seeker and wherein the job seeker presented is correlated to the available employment opportunity;
reviewing the job seeker data, wherein the employer reviews the qualification data and experience of the job seeker; and
contacting the job seeker, wherein the employer contacts the job seeker via the software application.

11. The method operable to correlate job seeker qualification with employment opportunities as recited in claim 10, wherein the profile account of the job seeker includes at least one of the following: name, age, photograph or personal statement.

12. The method operable to correlate job seeker qualification with employment opportunities as recited in claim 11, wherein data collected about the available employment opportunities include at least the following: geo-location, industry, required experience, salary available and required education level.

13. The method operable to correlate job seeker qualification with employment opportunities as recited in claim 12, wherein the plurality of employers can view job seekers with whom the software application has not calculated the correlation between the job seeker and employment opportunity.

14. The method operable to correlate job seeker qualification with employment opportunities as recited in claim 13, and further including the step of identifying a list of preferred employers, wherein the job seeker enters a list of preferred employers.

15. The method operable to correlate job seeker qualification with employment opportunities as recited in claim 14, and further including the step of inhibiting access to the profile account of the job seeker, wherein the job seeker identifies employers that will be inhibited from viewing the profile account of the job seeker.

16. The method operable to correlate job seeker qualification with employment opportunities as recited in claim 15, and further including the step of indicating previous employment with the employer, wherein the graphical map will display an icon of a different color for a job seeker that has been employed with an employer viewing the graphical map.
